(19) United States
(12) Patent Application Publication
(10) Pub. No.: US 2015/0309998 A1
(43) Pub. Date: Oct. 29, 2015

(54) METHOD AND APPARATUS FOR PLAYING A MP4 FILE CONTAINER WHILE GENERATING SUCH A FILE

(71) Applicants: Ramkumar Perumanam, Indianapolis, IN (US); Jens Cahnbley, Princeton Junction, NJ (US); Ishan Mandrekar, Monmouth Junction, NJ (US)

(72) Inventors: Ramkumar Perumanam, Indianapolis, IN (US); Jens Cahnbley, Princeton Junction, NJ (US); Ishan Mandrekar, Monmouth Junction, NJ (US)

(73) Assignee: THOMSON LICENSING, Issy de Moulineaux (FR)

(21) Appl. No.: 14/370,003

(22) PCT Filed: Jan. 12, 2012
(86) PCT No.: PCT/US2012/021137

§ 371 Date: Jun. 17, 2015

(51) Int. Cl. G06F 17/30

(52) U.S. Cl. CPC G06F 17/3002; G06F 17/30094

(57) ABSTRACT

A method for enabling playback of an MP4 file wrapper/container during generation of the same includes the creation of an auxiliary index file at initiation of the MP4 file generation and the updating of the auxiliary index file simultaneously with the MP4 file being generated. The auxiliary index file provides the instantaneous playback of a partially generated MP4 file container up to a last data block written to the MP4 file wrapper. Furthermore, by fixing the size of the index records that make up the auxiliary index file, a device can seek to any index record within the auxiliary index file at constant time and read the attributes of a frame such as data block location and frame offset.

### BACKGROUND

1. Technical Field

The present invention relates to the creation and playback of multimedia files that make use of a file container/wrapper. More particularly, it relates to a method and apparatus for enabling playback of a file using a MP4 file container format while the file is still being generated.

2. Related Art

A multimedia file container or multimedia file wrapper is a file format that is used to store or “wrap” various forms of multimedia data such as video, audio, text, subtitles, and the like together in the same “package” without having to have separate files for each of these data types. Most times, different types of data are interleaved together when placed in a file container, but this interleaving operation is not necessary for such data to be placed together in a file container. An MP4 is a version of a multimedia file container as defined by MPEG-4 Part 14 (ISO/IEC 14496-14:2003). Typically, when an MP4 file container is used, such a file could be played back only after the file itself is created and all of the data for the file is written and finalized. This is a big disadvantage when the file contents are quite large and such data need to be continuously tweaked by content creation/editing tools used to edits such MP4 files. Specifically, MP4 files typically store media data as well as metadata in the form of various tables to facilitate access to the media data, where most times these tables are the last thing to be updated while an MP4 file is being created or edited. Hence, the playback of an MP4 file for editing purposes becomes difficult when the tables that reference various parts of the file are not available until the file creation or updating of an MP4 file are completed.

### SUMMARY

According to an implementation, a file container is being generated that can store various audio, video, and other types of information. While the file container is being generated, an auxiliary file index table which corresponds to the file container is also generated. The use of the file index allows the reading of information from the file container while the container is being generated.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a view of the format of an MP4 file according to the prior art;

FIG. 2 is a view of an embodiment of a format of an MP4 file as a result of the application of an exemplary embodiment;

FIG. 3 is a flow diagram showing an embodiment of a method for playing an MP4 file during creation of the same according to an exemplary embodiment;

FIG. 4 is a flow diagram showing an embodiment of a for playing an MP4 file during creation of the same according to an exemplary embodiment;

FIG. 5 is a block diagram of an MP4 multimedia file creator and reader according to an exemplary embodiment;

FIG. 6 shows an example of the index file according to an exemplary embodiment; and

FIG. 7 shows another example of one index record including key attributes according to an exemplary embodiment.

### DETAILED DESCRIPTION

The present principles are directed to the playback of multimedia container files while such files are being created or edited. More specifically, the present principles are described in view of the MP4 file container/file wrapper format, although the principles can be applied to other file container/file container formats.

The present description illustrates the present principles through exemplary embodiments of the invention. It will thus be appreciated that those skilled in the art will be able to devise various arrangements that, although not explicitly described or shown herein, embody the present principles.

All examples and conditional language recited herein are intended for informational purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment”, “in an embodiment”, or “an exemplary embodiment” as well any other variations, appearing in various places throughout the specification are not necessarily all referring to the same embodiment.

An exemplary embodiment enables a editing or playback application to playback an MP4 file while such a file is still being created. In addition, this exemplary embodiment also provides random access to the media data stored in the file thereby enabling additional features such as trick modes which can access different positions within the file either in forward or reverse direction.

Currently available commercial MP4 file creators do not appear to allow playing back a file until the generation of such a file is completed. As previous stated, most times a file container has audio, video, and other types of data interleaved throughout the file. These data chunks or “atoms” in the case of the MP4 file container nomenclature require tables to point to the various elements of the MP4 file container. Such tables do not exist until the very end of a generating or updating operation for an MP4 file container.

Also in case the MP4 file contains compressed video of the format H.264, there is a significant difficult in finding video “atoms” within the file when performing an action such as trick play that requires a random access operation. Moreover, when performing a random access based seek operation in a file, the times for such an operation are not constant because the file size and the seek position in a file. Also several atoms located in various positions within the MP4 file have to be consulted to locate media data during a seeking operation thereby resulting in many disk access operations. The exemplary method provides a constant seek time to locate a media frame irrespective of the file size of a file container and also minimizes the disk accesses in retrieving the appropriate media data from such a file container.

An exemplary embodiment presents a method for aiding the playing back contents of an MP4 file while the file is being generated. In addition, the exemplary method enables efficient random access of the file container either during or after the operation of file generation. The random access operation then enables various playback features such as trick mode play in a forward or reverse direction which can be implemented using a single or multiple frames using the principles described herein.

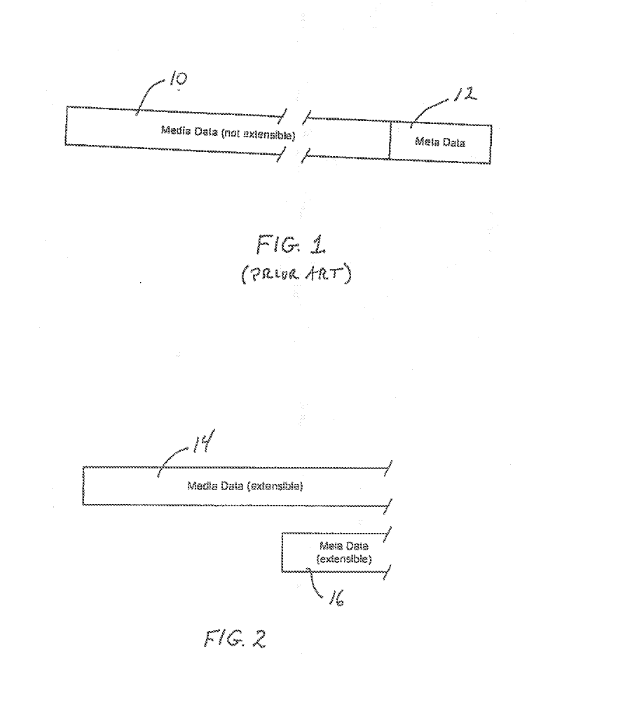

FIG. 1 shows a view of a conventional form of a MP4 file having a non-extensible media data portion 10 and a related metadata section 12. Referring to FIG. 2 and in accordance with an exemplary embodiment, a MP4 media file is created where the media data portion 14 is extensible and the Metadata (i.e., auxiliary index file) portion 16 is also extensible but is maintained separately from the file.

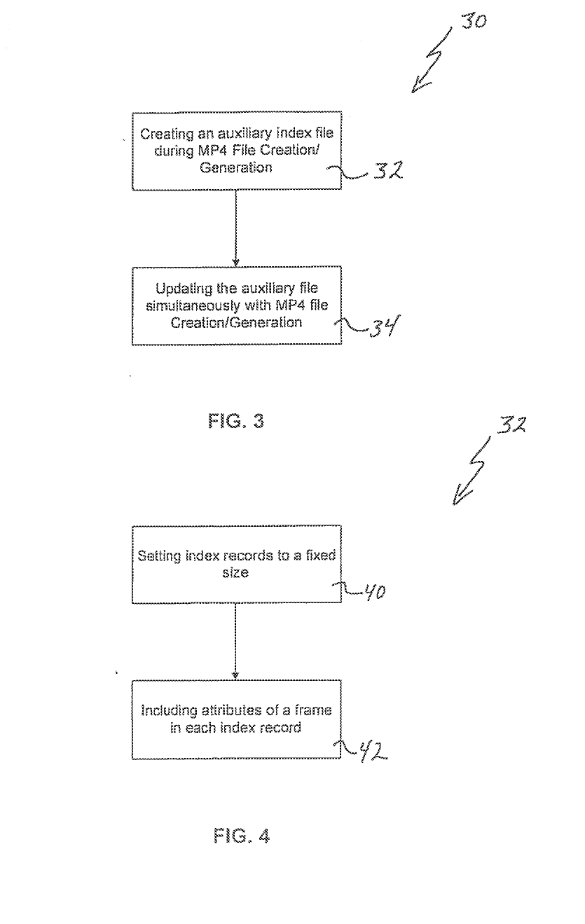

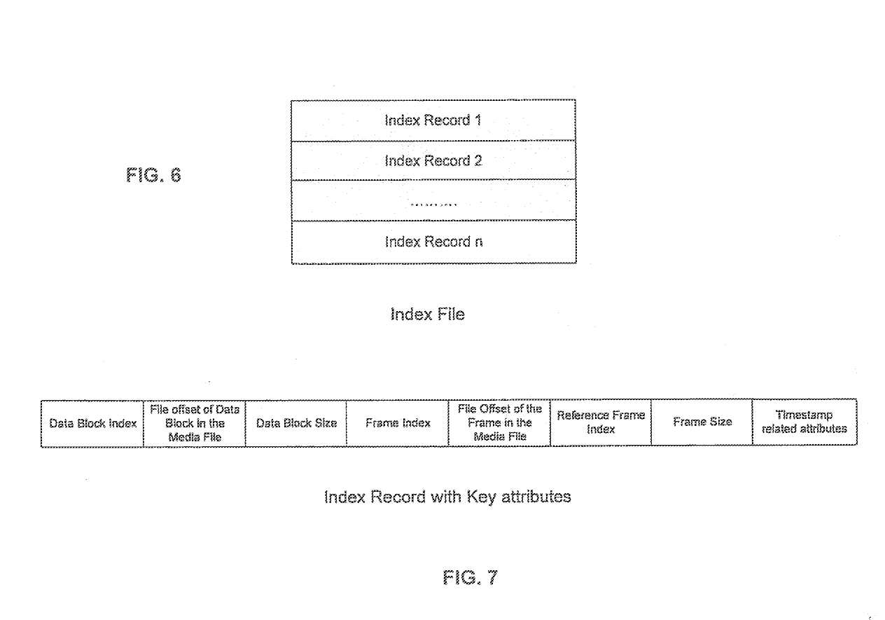

Referring to FIG. 3 and in accordance with exemplary implementation of the invention, a method 30 for the playback of a partially generated MP4 file is accomplished by creating and updating an auxiliary index file during the file creation process (step 32) in addition to the actual MP4 file that is being generated. An auxiliary index file consists of fixed size index records, as shown in FIG. 6, that has an index file having 1-n index records. FIG. 7 shows an exposed view of what is stored in an index file which can include information such as attributes of a video frame, the nearest reference frame, a file offset used to locate the data block containing a video frame, the offset within the data block, and timestamp related attributes.

Referring back to FIG. 3, the auxiliary index file is kept up to date in real time (step 34) while a corresponding MP4 file is being generated whereby the index file contains information to read and playback up to the last data block written to the MP4 file. Therefore the exemplary embodiment enables playback of partial file while the MP4 file is still being written up to the last data block that was written to the MP4 file.

In accordance with another exemplary embodiment, the created auxiliary index file functions for a different purpose. That is, the index file enables a device to seek to any frame within the file container with a constant seek time. FIG. 4 shows an exemplary method for the creation of the index file of step 32, where index records are set to a fixed size (step 40) and the auxiliary index file includes attributes of a frame in each index record (step 42). As mentioned previously, FIG. 7 shows an example of the index record with key attributes. The attributes shown are for illustrative purposes only and those of skill in the art will recognize that index records could also include additional attributes to those shown without departing from the intended scope of the present invention. Thus, a device can seek any index record within the auxiliary index file at a constant time and read the attributes of a frame such as, for example, data block location, frame offset, frame index, and the like. Since the index record points to the data block starting with a reference frame, a device can start decoding from the nearest reference frame.

If the whole data chunk (or atom in the case of an MP4 file) is decoded as a unit and the decoded frames from the data chunk are stored in a memory or storage medium, a device can then support trick mode play by accessing such a memory or storage medium. If the playback of a file container continues beyond the boundaries of current data block in the memory or storage medium, the previous or next data block can be read and the same process for playback is repeated. A device by can also predict the next data block ahead which will be accessed for playback based on the direction of current playback and end up decoding this predicted data block before such a data block is required for playback. Thus, the described auxiliary index file mechanism opens up many possibilities for the random seeks and trick mode access of the underlying media content.

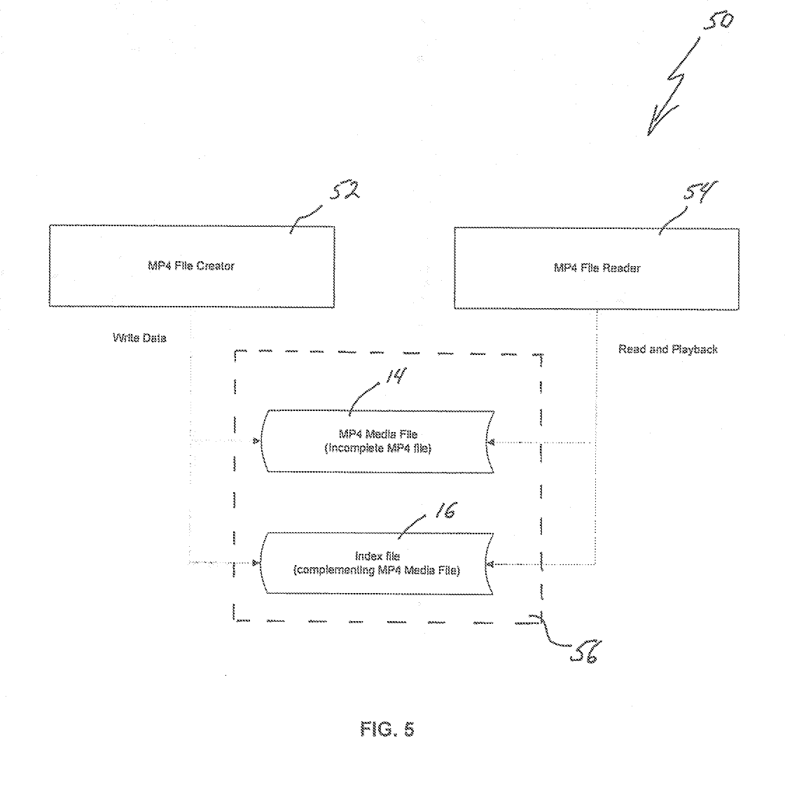

FIG. 5 shows a block diagram of an apparatus 50 according to an exemplary embodiment. The MP4 file creator 52 is an MP4 file writer that creates an MP4 media file 14 and simultaneously creates the associated auxiliary index file 16. As shown, the MP4 reader or player 54 can read both the MP4 media file (even when incomplete) and the associated auxiliary index file 16. The MP4 reader/player 54 can then read/playback the MP4 file by using the associated auxiliary index while the MP4 file creation is still in progress. During the creation of the MP4 file, the incomplete MP4 media file 14 and the auxiliary index file 16 can be stored in the same storage memory 56 used for generating the MP4 file. Thus, when playing back an incomplete MP4 file which is still in the process of being generated, a device does not have to rely on any additional memory in that the device can use the same memory used for generating the MP4 file.

Those of skill in the art will recognize that as a result of the implementation of the above present principles, the finally created MP4 file wrapper is backward compatible and can be played back with any MP4 player after the file creation process is completed. Thus, media file's final file format remains unchanged by application of the described present principles.

Since the auxiliary index file created by the present invention provides\information about frames and other data stored in the media file (MP4 file), such information can be exploited by custom file reader/players that understand the layout of the exemplary index file to provide additional trick modes.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope of the present principles. All such changes and modifications are intended to be included within the scope of the present principles as set forth in the appended claims.

1. A method for playing back a file container during generation of the file container, the method comprising the steps of:
creating (32) an auxiliary index file during generation of the file container;
updating (34) the auxiliary file index simultaneously while proceeding with the generation of the file container; and
using the auxiliary index file to playback a partially created file container prior to completion of the generation of the file container up to a last data block written to the partially created file container.

2. The method of claim 1, further comprising setting (40) one or more index records that make up the auxiliary index file to a fixed size.

3. The method of claim 2, wherein the setting of one or more index records further comprises including attributes (42) of a frame in each index record, the attributes including at least data block location and frame offset.

4. The method of claim 1, where the steps of creating and updating, further include storing the auxiliary index file in a storage device along with the partially created file container.

5. The method of claim 1, wherein the file container is a MP4 file container.

6. An apparatus for playing back an MP4 file during creation, the apparatus comprising:
an MP4 file creator (52) for generating the MP4 file and a corresponding auxiliary index file; and
an MP4 player (54) configured to read and playback a partially created MP4 file utilizing the corresponding auxiliary index file.

7. The apparatus according to claim 8, further comprising a storage device (56) coupled with both the MP4 file creator (52) and the MP4 file reader (54), the storage device storing the partially created MP4 file and corresponding auxiliary file.

8. The apparatus according to claim 7, wherein the MP4 file creator continuously updates the auxiliary index file during the MP4 file creation such that the auxiliary index file corresponds at all times with the partially created MP4 file.

9. An apparatus for playing back an MP4 file during creation, the method comprising the steps of:
means for creating an auxiliary index file during MP4 file generation; and
means for updating the created auxiliary file simultaneously with the MP4 file creation;
wherein the auxiliary index file provides instantaneous playback capability of a partially created MP4 file up to a last data block written to the MP4 file.

10. The apparatus of claim 9, further comprising means for setting index records that make up the auxiliary index file to a fixed size.

11. The apparatus of claim 10, wherein the means for setting index records further comprises means for including attributes of a frame in each index record, the attributes including at least data block location and frame offset.

12. The apparatus of claim 9, further comprising storing means for storing the auxiliary index file along with its corresponding partially created MP4 file.
